(19) United States
(12) Patent Application Publication
(10) Pub. No.: US 2003/0180085 A1
(43) Pub. Date: Sep. 25, 2003

(54) All in one home and yard maintenance tool package and method therefor

(76) Inventor: David P. Hughes, Lake Havasu, AZ (US)

Correspondence Address: WEISS & MOY PC, 4204 NORTH BROWN AVENUE, SCOTTSDALE, AZ, 85251, US

(21) Appl. No.: 10/102,190

(22) Filed: Mar. 19, 2002

(51) Int. Cl. A46B 11/06; A01D 7/00; A46B 11/00; A46B 5/00

(52) U.S. Cl. 401/289; 56/400.04; 56/400.05; 15/144.3; 15/145; 15/175; 15/176.2; 401/195

(57) ABSTRACT

A home and yard maintenance tool for performing a plurality of different task is disclosed. The home and yard maintenance tool has a handle section. A plurality of different home and yard accessory attachments are further provided. Each of the different attachments may be removably coupled to the handle for performing the plurality of different task.

### BACKGROUND OF THE INVENTION

1. Field of the Invention

This invention relates to home and lawn maintenance equipment and, more specifically, to an all in one home and yard maintenance tool package.

2. Description of the Prior Art

Presently, more people are taking the time to perform household chores such as home and yard maintenance. In order to do many of these household chores, certain tools are required. For example, home and/or yard maintenance work may require a rake, shovel, broom, mop, window squeegee, etc.

The problem with home and yard maintenance is that many people do not own all the necessary tools. Because of this, many people will go to their local hardware store to purchase each of the above items. This can be quite costly. Furthermore, all of the above equipment can take up quite a bit of space in the garage or tool shed of the owner.

Therefore, a need existed to provide an all in one home and yard maintenance tool. The all in one home and yard maintenance tool will not require people to purchase each individual tool for home or yard maintenance work. The all in one home and yard maintenance tool will also take up less space than purchasing separate home and yard maintenance tools.

### SUMMARY OF THE INVENTION

In accordance with one embodiment of the present invention, it is an object of the present invention to provide an all in one home and yard maintenance tool.

It is another object of the present invention to provide an all in one home and yard maintenance tool that will not require people to purchase each individual tool for home or yard maintenance work.

It is still another object of the present invention to provide an all in one home and yard maintenance tool that will take up less space than purchasing separate home and yard maintenance tools.

### BRIEF DESCRIPTION OF THE EMBODIMENTS

In accordance with one embodiment of the present invention a home and yard maintenance tool for performing a plurality of different task is disclosed. The home and yard maintenance tool has a handle section. A plurality of different home and yard accessory attachments are further provided. Each of the different attachments may be removably coupled to the handle for performing the plurality of different task.

In accordance with another embodiment of the present invention, a home and yard maintenance tool for performing a plurality of different task is disclosed. The tool has a handle section. The handle section is hollow to allow a fluid to flow through the handle section. The handle section is comprised of a plurality of sections wherein each section is removably coupled to a successive section. A plurality of different home and yard accessory attachments are provided. Each attachment is removably coupled to the handle for performing the plurality of different task. A support member is coupled to the handle section and to an accessory attachment to be used. The support member is used to secure and hold the accessory attachment to be used to the handle section.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is an elevated front view of one embodiment of the all in one home and yard maintenance tool of the present invention.

FIG. 2 is an exploded view of the all in one home and yard maintenance tool depicted in FIG. 1.

FIG. 3 is an elevated perspective view of one attachment of the all in one home and yard maintenance tool of the present invention.

FIG. 4 is an elevated perspective view of another attachment of the all in one home and yard maintenance tool of the present invention.

FIG. 5 is an elevated perspective view of another attachment of the all in one home and yard maintenance tool of the present invention.

FIG. 6 is an elevated perspective view of another attachment of the all in one home and yard maintenance tool of the present invention.

FIG. 7 is an elevated perspective view of another attachment of the all in one home and yard maintenance tool of the present invention.

FIG. 8 is an elevated perspective view of another attachment of the all in one home and yard maintenance tool of the present invention.

FIG. 9 is an elevated perspective view of another attachment of the all in one home and yard maintenance tool of the present invention.

### DETAILED DESCRIPTION OF THE PREFERRED EMBODIMENT

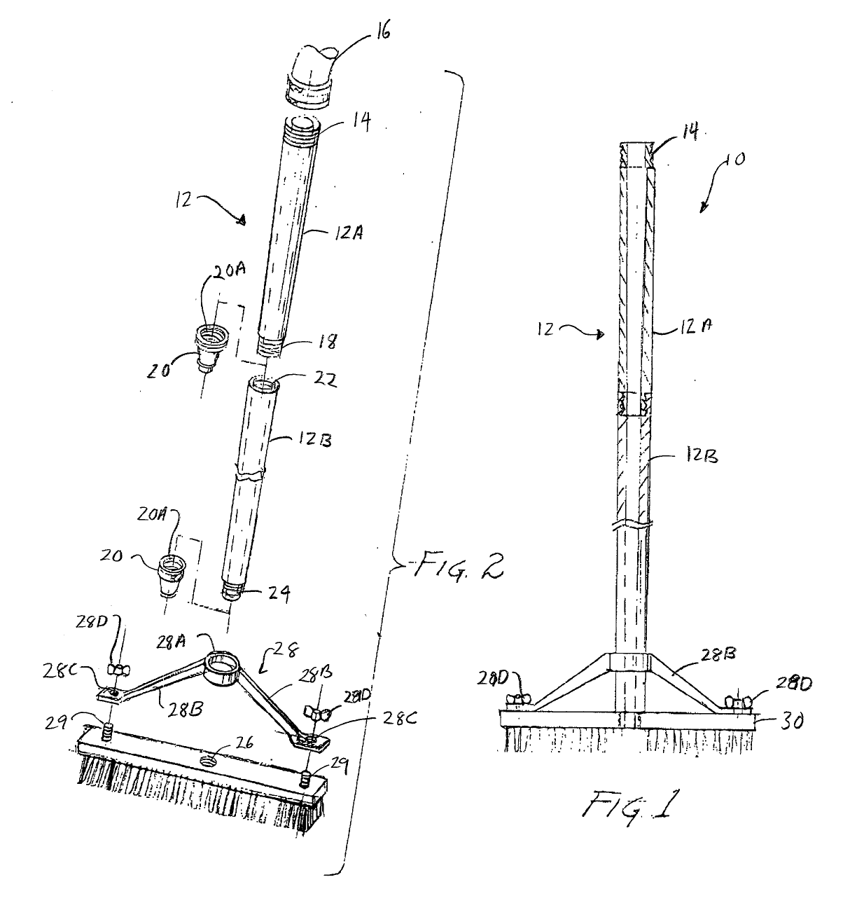

Referring to FIGS. 1 and 2 wherein like numerals and symbols represent like elements, the all in one home and yard maintenance tool 10 (hereinafter tool 10) is shown. The tool 10 is comprised of a handle section 12. The handle section 12 is provided so that a user of the tool 10 may hold/grasp the tool 10. The handle section 12 may be made out of a variety of different materials. For example, the handle section 12 may be made from wood, a light weight metal such as aluminum, plastic, fiberglass, or the like. It should be noted that the listing of the above elements are used as an example and should not be seen as to limit the scope of the present invention.

The handle section 12 may be a solid member or a hollow member. If the handle section 12 is a hollow member, the handle section 12 may be used as a high pressure sprayer. This will be described below.

The handle section 12 may be formed of one or more parts. A single part handle section 12 has the benefit of being easier and cheaper to construct. However, a multiple part handle section 12 also has benefits. By having a plurality of parts, one may adjust the length of the handle section 12 to the size of the user. Furthermore, by having a plurality of parts, one may easily dismantle the handle section 12 for easy storage and transport.

In accordance with one embodiment of the present invention, the handle section 12 will have a first section 12A. The first section 12A will be removably coupled to a second section 12B. The first section 12A and the second section 12B may be coupled together in a plurality of different manners. For example, the first section 12A and the second section 12B may be telescopically coupled together, threadedly coupled together, ball joint coupled, and the like. It should be noted that the above listing is given as an example and should not be seen as to limit the scope of the present invention.

As shown in the embodiment depicted in FIGS. 1 and 2, the first section 12A is a hollow member. The first section 12A will have a threaded top section 14 located on an outer surface of the first section 12A. The threaded top section 14 will allow the first section 12A to be removably coupled to an end of a hose 16. The first section 12A will further have a threaded bottom section 18 located on an outer surface of a bottom section of the first section 12A. The threaded bottom section 18 will have two main purposes. The first is to couple the first section 12A to the second section 12B. The second is to allow a nozzle attachment 20 to be removably coupled to the threaded bottom section 18 of the first section 12A.

The nozzle attachment 20 is a conical shape device. The nozzle attachment 20 has a hollow interior. A threaded section 20A is located in the interior of a top section of the nozzle attachment 20. The threaded section 20A of the nozzle attachment 20 will engage the threaded bottom section 18 of the first section 12A to form a waterproof seal. The nozzle attachment 20 will allow the tool 10 to function as a high pressure washer when the tool 10 is attached to a hose 16.

The second section 12B is also a hollow member. The second section 12B will have a threaded section 22 located in the interior of a top section of the second section 12B. The second section 12B will also have a threaded bottom section 24 located on the outer surface of a bottom section of the second section 12B. The threaded section 22 of the second section 12B will engage the threaded bottom section 18 of the first section 12A. This will allow one to have a longer length handle section 12. Furthermore, a water proof seal is formed when threaded section 22 of the second section 12B engages the threaded bottom section 18 of the first section 12.

The nozzle attachment 20 may be removably coupled to the threaded bottom section 24 of the second section 12B. The threaded section 20A of the nozzle attachment 20 will engage the threaded bottom section 24 of the second section 12B to form a waterproof seal. The nozzle attachment 20 will allow the tool 10 to function as a high pressure washer when the tool 10 is attached to a hose 16. The second section 12B will allow the tool 10 to have a longer reach.

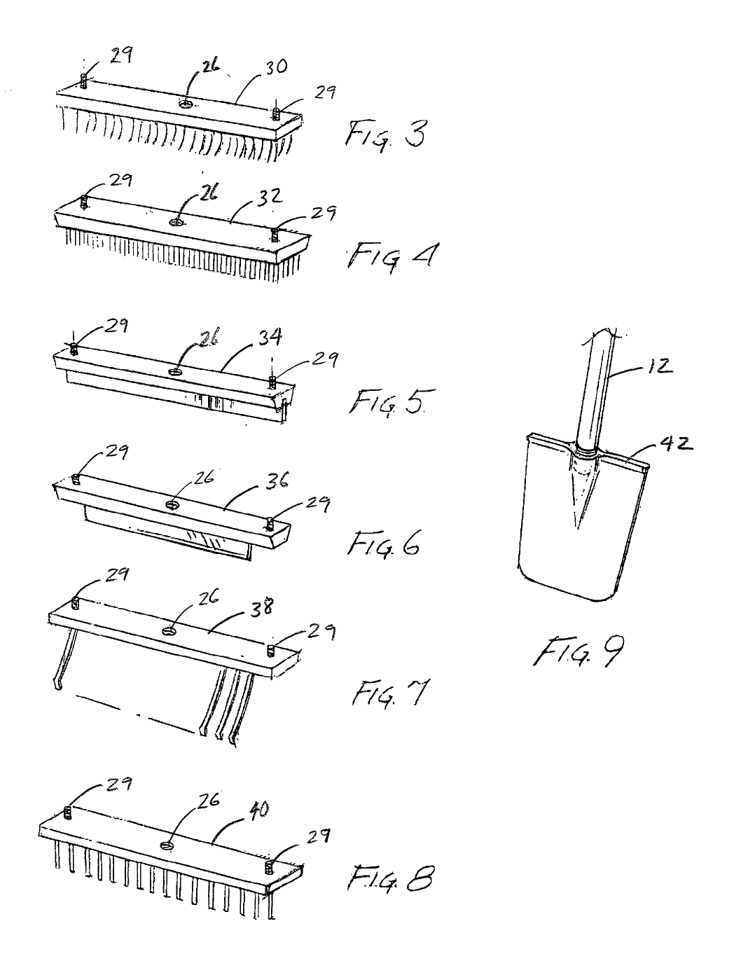

The threaded bottom section 24 of the second section 12B may be coupled to a plurality of different accessories. Some examples of the different accessories are shown in FIGS. 1-8. For example, FIGS. 1-3 show a fine broom head 30. FIG. 4 depicts a coarse broom head 32. FIG. 5 shows a floor scraper/ice scraper 34. FIG. 6 depicts a window squeegee attachment 36. FIG. 7 shows a leaf rake attachment 38. FIG. 8 shows a hard rake attachment 40. FIG. 9 depicts a shovel attachment 42. Other attachments may include a mop attachment, a hoe attachment, a razor blade attachment, and the like. It should be noted that other attachments may be used and the listing of the above should not be seen as to limit the scope of the present invention.

Each of the accessories 30-42 will have an opening 26 located in a central section of the body of the accessory 30-42. The opening 26 will have a threaded interior. The threaded interior of the opening 26 will allow both the threaded bottom section 18 of the first section 12A and the threaded bottom section 24 of the second section 12B to be removably coupled to each of the different accessories 30-42.

The tool 10 may further have a support member 28. The support member 28 would be coupled to the handle section 12 and to the accessory 30-42 currently in use. The support member 28 would be used to secure and hold each accessory 30-42 to the handle section 12. In accordance with one embodiment, the support member 28 has a ring member 28A. The ring member 28A will have a diameter which is wide enough to allow the handle section 12 to slide through the ring member 28. A pair of support rods 28B extend down from the ring member 28A. On the end of each support rod 28B is an opening 28C. The opening 28C is used to secure the support member 28 to the different accessories 30-42.

Each of the different accessories 30-42 may have a pair of support pegs 29. The support pegs 29 extend up and out of a top section of each accessory 30-42. The support pegs 29 are generally located at opposite ends of the accessory as shown in the drawings. If a support member 28 is used, each support peg 29 will fit through the opening 28C in the support rod 28B. A device 28D is then used to secure the support rod 28B to the support peg 29. Some examples of the device 28D may be a nut, a butterfly nut, etc. It should be noted that the above are just examples and should not be seen as to limit the scope of the present invention.

The tool 10 may further have a carrying case. The carrying case will allow the user to have a common storage place for the handle section 12 and the multiple accessories 30-42. The carrying case will further allow the user to easily transport the tool 10.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A home and yard maintenance tool for performing a plurality of different task comprising:
a handle section; and
a plurality of different home and yard accessory attachments removably coupled to the handle for performing the plurality of different task.

2. A home and yard maintenance tool in accordance with claim 1 wherein the handle section is hollow to allow a fluid to flow through the handle section.

3. A home and yard maintenance tool in accordance with claim 1 wherein the handle section comprises a plurality of sections wherein each section is removably coupled to a successive section.

4. A home and yard maintenance tool in accordance with claim 3 wherein the handle section comprises:
a first section having a threaded top section located on an outer surface of the first section and a threaded bottom section located on an outer surface of a bottom section of the first section; and
a second section having a threaded top section located on an interior surface of the second section and a threaded bottom section located on an outer surface of a bottom section of the second section.

5. A home and yard maintenance tool in accordance with claim 4 wherein the threaded top section of the second section engages the threaded bottom section of the first section to form a liquid tight seal.

6. A home and yard maintenance tool in accordance with claim 4 further comprising a nozzle attachment which is removably coupled to both the first section and the second section to allow the tool to function as a high pressure washer.

7. A home and yard maintenance tool in accordance with claim 6 wherein the nozzle attachment comprises a conical shaped device having a hollow interior and a threaded section located in the interior of a top section of the nozzle attachment, the threaded section of the nozzle attachment being used to engage the threaded bottom section of the first section and the threaded bottom section of the second section to allow the tool to function as a high pressure washer.

8. A home and yard maintenance tool in accordance with claim 1 further comprising a support member coupled to the handle section and to an accessory attachment to be used to secure and hold the accessory attachment to be used to the handle section.

9. A home and yard maintenance tool in accordance with claim 8 wherein the support member comprises:
a ring member having a diameter slightly larger than a diameter of the handle section;
a pair of support rods coupled to and extending down from the ring member wherein the pair of support rods are removably coupled to the accessory attachment to be used.

10. A home and yard maintenance tool in accordance with claim 9 wherein the accessory attachment to be used comprises:
a body section;
a threaded opening centrally located on the body section for removably coupling the handle section to the accessory attachment to be used; and
a pair of peg members extending up and out of the body section for coupling the pair of support rods to the accessory attachment to be used.

11. A home and yard maintenance tool in accordance with claim 1 wherein the plurality of different home and yard accessory attachments comprises at least a broom head.

12. A home and yard maintenance tool in accordance with claim 1 wherein the plurality of different home and yard accessory attachments comprises at least a floor/ice scraper.

13. A home and yard maintenance tool in accordance with claim 1 wherein the plurality of different home and yard accessory attachments comprises at least a razor blade.

14. A home and yard maintenance tool in accordance with claim 1 wherein the plurality of different home and yard accessory attachments comprises at least a window squeegee.

15. A home and yard maintenance tool in accordance with claim 1 wherein the plurality of different home and yard accessory attachments comprises at least a rake head.

16. A home and yard maintenance tool in accordance with claim 1 wherein the plurality of different home and yard accessory attachments comprises at least a shovel head.

17. A home and yard maintenance tool for performing a plurality of different task comprising:
a handle section wherein the handle section is hollow to allow a fluid to flow through the handle section, the handle section comprising a plurality of sections wherein each section is removably coupled to a successive section;
a plurality of different home and yard accessory attachments removably coupled to the handle for performing the plurality of different task; and
a support member coupled to the handle section and to an accessory attachment to be used to secure and hold the accessory attachment to be used to the handle section.

18. A home and yard maintenance tool in accordance with claim 17 wherein the handle section comprises:
a first section having a threaded top section located on an outer surface of the first section and a threaded bottom section located on an outer surface of a bottom section of the first section; and
a second section having a threaded top section located on an interior surface of the second section and a threaded bottom section located on an outer surface of a bottom section of the second section.

19. A home and yard maintenance tool in accordance with claim 18 further comprising a nozzle attachment which is removably coupled to both the first section and the second section to allow the tool to function as a high pressure washer.

20. A home and yard maintenance tool in accordance with claim 17 wherein the support member comprises:
a ring member having a diameter slightly larger than a diameter of the handle section;
a pair of support rods coupled to and extending down from the ring member wherein the pair of support rods are removably coupled to the accessory attachment to be used.

21. A home and yard maintenance tool in accordance with claim 20 wherein the accessory attachment to be used comprises:
a body section;
a threaded opening centrally located on the body section for removably coupling the handle section to the accessory attachment to be used; and
a pair of peg members extending up and out of the body section for coupling the pair of support rods to the accessory attachment to be used.
